(19) United States
(12) Patent Application Publication
(10) Pub. No.: US 2021/0017435 A1
(43) Pub. Date: Jan. 21, 2021

(54) LATENT HEAT STORAGE COMPOSITE HAVING NETWORK OF PROTECTIVE NANOSTRUCTURES

(71) Applicant: Industry-University Cooperation Foundation Hanyang University, Seoul (KR)

(72) Inventors: Dong Rip KIM, Seoul (KR); Hyeon Woo Son, Busan (KR); Su Ho Kim, Yongin-si (KR); Chang Sung Heu, Seoul (KR); Heung Soo Lee, Seoul (KR)

(73) Assignee: Industry-University Cooperation Foundation Hanyang University, Seoul (KR)

(21) Appl. No.: 16/931,624

(22) Filed: Jul. 17, 2020

(30) Foreign Application Priority Data
Jul. 19, 2019 (KR) 10-2019-0087858
Sep. 20, 2019 (KR) 10-2019-0115976

(51) Int. Cl. C09K 5/06; F28D 20/02; C01G 3/02

(52) U.S. Cl. CPC C09K 5/063; B82Y 30/00; C01G 3/02; F28D 20/023

(57) ABSTRACT

The present disclosure relates to a novel high-performance latent heat storage composite manufactured by forming a network of protective nanostructures on the surface of a metal material having high thermal conductivity. Through a low volume content of a network having high thermal conductivity, high-density heat capacity may be secured. In addition, through use of a metal-based material having high thermal conductivity, thermal conductivity may be increased by about 7 times compared to a conventional pure phase change material.

### CROSS-REFERENCE TO RELATED APPLICATIONS

This application claims priority to Korean Patent Application No. 10-2019-0087858, filed on Jul. 19, 2019, and Korean Patent Application No. 10-2019-0115976, filed on Sep. 20, 2019, in the Korean Intellectual Property Office, the disclosures of each of which are incorporated herein by reference.

### BACKGROUND OF THE DISCLOSURE

### Field of the Disclosure

The present disclosure relates to a novel high-performance latent heat storage composite manufactured by forming a network of protective nanostructures on the surface of a metal material having high thermal conductivity.

### Description of the Related Art

Latent heat storage materials are materials that store energy in the process of absorbing or releasing heat generated during solid-liquid phase change using a phase change material. Among such latent heat storage materials, latent heat storage materials used at high temperatures are applied to manage heat generated by solar power plants, waste heat generated by automobile engines, and waste heat generated at industrial sites.

The required performance of a latent heat storage material is as follows. First, the latent heat storage material must be capable of storing high-density heat during a phase change process. Second, the latent heat storage material must have excellent thermal conductivity to enable rapid heat transfer. Third, the latent heat storage material must have excellent durability so that the latent heat storage material is not affected even when a phase change process is repeated.

Recently, as depletion of fossil fuels due to increased energy consumption has emerged as a problem, efficient energy consumption has attracted attention. Accordingly, energy utilization technologies using phase change materials capable of absorbing/releasing heat generated during a phase change process are drawing attention. The phase change materials have high storage density when storing heat. Accordingly, when the phase change materials are used, thermal energy storage efficiency may be increased, and thus the phase change materials may be used as efficient energy storage materials in homes and industries.

In particular, for storage of waste heat from solar plants and exhaust gases, molten salts including nitrates, chlorides, and carbonates and salt compositions are attracting attention due to phase change and high energy storage density at high temperature. However, such phase change materials have limitations in that the phase change materials have high corrosiveness and low thermal conductivity, and stability is required when applied to real systems. Due to high corrosiveness by molten salts and salt compositions, a high-thermal conductivity filler is required as a limited material. In addition, a corrosion process causes deterioration of a phase change material due to decomposition of a chemical composition.

To solve the above-described limitations of phase change materials such as molten salts and salt compositions, there are three representative solutions: encapsulation of the phase change material, use of a porous matrix, and addition of a highly conductive nanomaterial. As the first solution, encapsulation of a nitrate salt or a chloride salt with an anti-corrosion material such as steel and borosilicate provides high thermal stability for a phase change material. A flexible polymer such as fluorinated ethylene propylene (FEP) or polytetrafluoroethylene (PTFE) is applied to nitrate using a hydraulic pressing method, and then nickel is deposited using an electroplating method. This process increases the mechanical strength of the phase change material, and stabilizes thermal cycles. As the second solution, infiltration of a liquid phase change material into a thermally conductive matrix such as copper foam, copper-steel alloy foam, graphite foam, and expanded graphite increases thermal conductivity 5 to 7 times as addition of 10 to 20 wt % of the matrix material. However, using a material susceptible to corrosion (e.g., copper) as porous foam for a molten salt may reduce the stability of thermal cycle operation due to crack formation. Accordingly, due to stability, a filler having corrosion resistance to a phase change material is required. Finally, when a highly conductive and corrosion-resistant nanomaterial including magnesium nanoparticles, carbon nanotubes, and graphene is dispersed in a molten salt and a salt composition, and 1.5 to 2.0 wt % of the nanomaterial is contained, thermal conductivity may be improved 1.5 to 1.6 times. Adding a large amount of the nanomaterial to a phase change material causes aggregation of the nanomaterial and deteriorates thermal performance.

Korean Patent No. 10-1401426 discloses a technology for preparing a phase-stable phase change material by injecting a phase change material into a porous material. However, in the above technology, materials having poor thermal conductivity are used, and thus thermal efficiency is low during heat absorption and heat dissipation. Korean Patent No. 10-1627183 discloses a method of manufacturing a polymer resin as a latent heat storage material in the form of a microcapsule having a phase change material as a core and a polymer resin as a shell using a material prepared by condensation polymerization of a melamine resin and formaldehyde. However, since a material having low thermal conductivity is used as a shell, thermal conductivity is low. Korean Patent No. 10-1801926 discloses a method of manufacturing a heat storage material by filling carbon nanotube particles with paraffin, which is a phase change material. However, this method has a limitation in that the connected network of a filler is difficult to form.

### SUMMARY OF THE DISCLOSURE

Therefore, the present disclosure has been made in view of the above problems, and it is an object of the present disclosure to provide a novel high-performance latent heat storage composite based on a network in which protective nanostructures are formed on a metal material having high thermal conductivity.

In accordance with one aspect of the present disclosure, provided is a latent heat storage composite including a flexible and foldable metal mesh; a network of thermally conductive metal oxide structures formed on the metal mesh; and a phase change material for applying the metal oxide structures.

The metal mesh may be a copper (Cu) mesh, an aluminum (Al) mesh, a nickel (Ni) mesh, a titanium (Ti) mesh, or a stainless steel mesh, and the metal mesh may be folded to have a shape created by combining one or more selected from the group consisting of a wave shape, a zigzag shape, a spiral shape, and a donut (co-annular) shape.

The metal oxide structures may be porous metal oxide nanowire structures applied to the metal mesh.

The phase change material may have a lower melting point than the metal mesh, and the phase change material may include organic phase change materials and molten salt-based, nitrate-based, chloride-based, or carbonate-based salt compound phase change materials.

The latent heat storage composite may control thermal diffusion depending on change in a volume percentage between the metal mesh and the phase change material, and the metal mesh may have a volume percentage of 1 to 20 vol % based on the latent heat storage composite.

In accordance with another aspect of the present disclosure, provided is a method of manufacturing a latent heat storage composite, the method including preparing a metal mesh; forming metal nanowire structures on the metal mesh; heat-treating the metal nanowire structures to convert the metal nanowire structures into metal oxide nanowire structures; and immersing, in a molten phase change material, the metal mesh on which the metal oxide nanowire structures are formed.

The metal mesh may be a copper (Cu) mesh, an aluminum (Al) mesh, a nickel (Ni) mesh, a titanium (Ti) mesh, or a stainless steel mesh, and the metal mesh may be folded to have a shape created by combining one or more selected from the group consisting of a wave shape, a zigzag shape, a spiral shape, and a donut (co-annular) shape.

The phase change material may have a lower melting point than the metal mesh, and the phase change material may include organic phase change materials and molten salt-based, nitrate-based, chloride-based, or carbonate-based salt compound phase change materials.

The metal mesh may have a volume percentage of 1 to 20 vol % based on the latent heat storage composite.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A is a schematic diagram showing a process of manufacturing protective nanostructures according to one embodiment of the present disclosure;

FIG. 1B is an SEM image of protective nanostructures according to one embodiment of the present disclosure;

FIG. 1C is XRD analysis results of protective nanostructures according to one embodiment of the present disclosure;

FIG. 1D is a TEM image of protective nanostructures according to one embodiment of the present disclosure, and FIG. 1E shows pore distribution;

FIG. 2A is a cross-sectional SEM image of protective nanostructures according to one embodiment of the present disclosure;

FIG. 2B shows thermal conductivity measurement results of protective nanostructures according to one embodiment of the present disclosure;

FIG. 3A illustrates a peeling test device for a latent heat storage composite according to one embodiment of the present disclosure;

FIG. 3B shows peeling test results of a latent heat storage composite according to one embodiment of the present disclosure;

FIG. 4 shows DSC analysis results of a latent heat storage composite according to one embodiment of the present disclosure;

FIG. 5A shows optical images of a latent heat storage composite according to one embodiment of the present disclosure;

FIG. 5B shows the DSC curves of a latent heat storage composite according to one embodiment of the present disclosure;

FIG. 5C shows the Fourier transform infrared (FTIR) spectra of a latent heat storage composite according to one embodiment of the present disclosure;

FIG. 6A shows images of a zigzag-type latent heat storage composite according to one embodiment of the present disclosure;

FIG. 6B shows images of a spiral-type latent heat storage composite according to one embodiment of the present disclosure;

FIG. 6C show thermal conductivity measurement results of a latent heat storage composite according to one embodiment of the present disclosure;

FIG. 7A shows a thermal diffusion performance analysis device for a latent heat storage composite according to one embodiment of the present disclosure;

FIG. 7B shows thermal images of a latent heat storage composite according to one embodiment of the present disclosure;

FIG. 7C shows the temperature profiles (heat-on) of a latent heat storage composite according to one embodiment of the present disclosure; and

FIG. 7D shows the temperature profiles (repeated heat-on and heat-off cycles) of a latent heat storage composite according to one embodiment of the present disclosure.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

Although terms used in the specification are selected from terms generally used in related technical fields, other terms may be used according to technical development and/or due to change, practices, priorities of technicians, etc. Therefore, it should not be understood that terms used below limit the technical spirit of the present disclosure, and it should be understood that the terms are exemplified to describe embodiments of the present disclosure.

Also, some of the terms used herein may be arbitrarily chosen by the present applicant. In this case, these terms are defined in detail below. Accordingly, the specific terms used herein should be understood based on the unique meanings thereof and the whole context of the present disclosure.

Meanwhile, terms such as “first” and “second” are used herein merely to describe a variety of constituent elements, but the constituent elements are not limited by the terms. The terms are used only for the purpose of distinguishing one constituent element from another constituent element.

In addition, when an element such as a layer, a film, a region, and a constituent is referred to as being “on” another element, the element can be directly on another element or an intervening element can be present.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, in the following description of the present disclosure, a detailed description of known functions and configurations incorporated herein will be omitted when it may make the subject matter of the present disclosure unclear. The terms used in the specification are defined in consideration of functions used in the present disclosure, and can be changed according to the intent or conventionally used methods of clients, operators, and users. Accordingly, definitions of the terms should be understood on the basis of the entire description of the present specification.

Hereinafter, embodiments of the present disclosure will be described in detail with reference to the accompanying drawings.

A latent heat storage composite of the present disclosure includes a flexible and foldable metal mesh; a network of thermally conductive metal oxide structures formed on the metal mesh; and a phase change material for applying the metal oxide structures.

The metal mesh may be a flexible and thermally conductive metal, and by introducing a network of thermally conductive metal oxide structures to the metal mesh, the metal mesh is provided as a filler in the latent heat storage composite of the present disclosure.

The network of thermally conductive metal oxide structures may be metal oxide nanowire structures formed continuously, and by forming the nanowire structures, a network of protective nanostructures having improved thermal conductivity and continuous arrangement may be provided.

The metal mesh may be a copper (Cu) mesh, an aluminum (Al) mesh, a nickel (Ni) mesh, a titanium (Ti) mesh, or a stainless steel mesh.

The metal mesh may be folded to have a shape created by combining one or more selected from the group consisting of a wave shape, a zigzag shape, a spiral shape, and a donut (co-annular) shape. More specifically, the metal mesh may be folded to have one of a wave shape, a zigzag shape, a spiral shape, and a donut (co-annular) shape, or may be folded to have a shape created by combing a wave shape and a zigzag shape or a shape created by combining a wave shape and a spiral shape. Thereby, heat transfer may be efficient.

The metal oxide structures may be applied to the metal mesh, and the metal mesh may be fully coated with the metal oxide structures.

The metal oxide structures may be porous metal oxide nanowire structures.

The metal oxide structures have excellent physical and chemical stability to phase change materials, and this feature enables stable operation of a latent heat storage composite during repeated heat cycles.

The phase change material may have a lower melting point than the metal mesh, and the phase change material may include organic phase change materials and molten salt-based, nitrate-based, chloride-based, or carbonate-based salt compound phase change materials.

The latent heat storage composite may control thermal diffusion depending on change in the volume percentage between the metal mesh and the phase change material, and the metal mesh may have a volume percentage of 1 to 20 vol %, preferably 3 to 7 vol %, based on the latent heat storage composite.

In addition, a method of manufacturing a latent heat storage composite of the present disclosure includes a step of preparing a metal mesh; a step of forming metal nanowire structures on the metal mesh; a step of heat-treating the metal nanowire structures to convert the metal nanowire structures into metal oxide nanowire structures; and a step of immersing, in a molten phase change material, the metal mesh on which the metal oxide nanowire structures are formed.

The metal mesh may be a copper (Cu) mesh, an aluminum (Al) mesh, a nickel (Ni) mesh, a titanium (Ti) mesh, or a stainless steel mesh.

The metal mesh may be folded to have a shape created by combining one or more selected from the group consisting of a wave shape, a zigzag shape, a spiral shape, and a donut (co-annular) shape. More specifically, the metal mesh may be folded to have one of a wave shape, a zigzag shape, a spiral shape, and a donut (co-annular) shape, or may be folded to have a shape created by combing a wave shape and a zigzag shape or a shape created by combining a wave shape and a spiral shape.

The phase change material may have a lower melting point than the metal mesh, and the phase change material may include organic phase change materials and molten salt-based, nitrate-based, chloride-based, or carbonate-based salt compound phase change materials.

The metal mesh may have a volume percentage of 1 to 20 vol %, preferably 3 to 7 vol %, based on the latent heat storage composite.

Hereinafter, the present disclosure will be described in more detail through examples. These examples are intended to illustrate the present disclosure more specifically, but the scope of the present disclosure is not limited by these examples. cl Manufacture Example 1

### Formation of Network of Protective Nanostructures on Copper Mesh

For a thermal conductive scaffold of a phase change material, porous copper oxide (CuO) nanowires were synthesized using chemical solution growth on a copper mesh. The copper mesh (wire diameter: 180 μm, 40 mesh, purity: 99%) was folded to have a desired shape (a zigzag or spiral shape), and then impurities were removed using 1 M HCl for 15 minutes at room temperature, followed by washing with ethanol and deionized water.

The washed copper mesh was immersed, at 25° C. for 10 minutes, in a solution prepared by mixing a 10 M aqueous NaOH solution and 0.18 M ammonium persulfate ((NH₄)₂S₂O₈) in a volume ratio of 27:73 to obtain a sample in which the Cu(OH)₂ nanowires (protective nanostructures) were formed on the copper mesh. After washing the sample with deionized water, a dehydration process was performed at 200° C. for 2 hours to form porous copper oxide nanowires (porous CuO NWs). Through the above processes, the copper mesh on which the porous copper oxide nanowires were formed was manufactured.

### Manufacture Example 2

### Formation of Network of Protective Nanostructures on Copper Plate

A copper plate on which porous copper oxide nanowires were formed was manufactured in the same manner as Manufacture Example 1, except that a copper (Cu) plate (thickness: 180 purity: 99.98%, Sigma Aldrich) was used instead of the copper mesh.

### EXAMPLE 1

### High-Performance Latent Heat Storage Composite_3 vol % of Filler

After solid lithium nitrate (LiNO₃) was melted by heating to 300° C. in a vacuum oven, vacuum infiltration was performed, using the molten lithium nitrate for 1 to 2 hours, on the copper mesh of Manufacture Example 1 on which porous copper oxide nanowires had been formed, and then solidification proceeded slowly at room temperature. Thereby, a lithium nitrate-based phase change composite (latent heat storage composite) was manufactured.

In this case, in the manufactured phase change composite, the volume percentage of the copper metal mesh (filler) on which the porous copper oxide nanowires were formed was 3 vol %. In this case, to adjust the volume percentage, the weight of the copper mesh on which porous copper oxide nanowires were formed and the weight of lithium nitrate were measured, and the weights were respectively converted into volumes using the densities of the phase change material (lithium nitrate) and copper (Cu) (Cu: 8.96 g/cm³, LiNO₃: 2.38 g/cm³).

More specifically, since the density of copper oxide (CuO) was 6.32 g/cm³ and the thickness (about 2 μm) of a copper oxide (CuO) layer and the height (6.6 μm) of the porous copper oxide nanowires were much smaller than the thickness (˜180 μm) of the copper mesh, the copper oxide and the porous copper oxide nanowires on the copper mesh were assumed to be copper, and the difference in weight before and after synthesis of the copper mesh and the copper oxide and the copper mesh and the porous copper oxide nanowires was neglected.

### EXAMPLE 2

### High-Performance Latent Heat Storage Composite_7 vol % of Filler

A phase change composite was manufactured in the same manner as Example 1, except that, in the manufactured phase change composite, the volume percentage of a copper metal mesh (filler) on which porous copper oxide nanowires were formed was 7 vol %.

### MEASUREMENT EXAMPLE

### Morphology

The morphology of porous copper oxide nanowires on a copper mesh was observed using a scanning electron microscope (SEM, S-4800, HITACH). The crystallinity of the porous copper oxide nanowires was observed using a transmission electron microscope (TEM, JEM 2100F, JEOL), and the pores of the porous copper oxide nanowires were characterized using image processing software (STREAM, OLYMPUS). X-ray diffraction (XRD) analysis was performed using an X-ray diffractometer (SmartLab, RIGAKU). The chemical structures of a latent heat storage composite and pure lithium nitrate were analyzed at 400 to 4,000 cm⁻¹ using a Fourier transform infrared spectroscope (FTIR, Nicolet IS50, THERMAL SCIENTIFIC).

### MEASUREMENT EXAMPLE

### Thermal Properties

The thermal conductivity (in this measurement example, it is assumed that the thermal conductivity of the copper plate of Manufacture Example 2 and the thermal conductivity of the copper mesh of Manufacture Example 1 were the same) of the porous copper oxide nanowires on the copper plate (a disk shape having a diameter of 25 mm and a thickness of 180 μm) of Manufacture Example 2 was measured by laser flash analysis (LFA, NETZSCH 467) at 25° C. Each of three samples was measured 5 times. The thermal conductivities of latent heat storage composites manufactured in Examples 1 and 2 and pure lithium nitrate were analyzed using a one-dimensional steady-state method (ASTM D5470). In particular, stainless steel (thermal conductivity: 16.3 W/m·K) was used as a reference material.

Heat was applied to the top side of the measurement device, and the temperature of the bottom side was controlled by a cooler. The diameter and height of the measurement sample were 2.5 cm and 1.5 cm, respectively. A type T thermocouple was used to measure temperature.

Latent heat was characterized in triplicate for each of three samples. The latent heat of the phase change composites (Examples 1 and 2) and pure lithium nitrate was analyzed using a differential scanning calorimeter (DSC 4000, PERKIN ELMER). Before measurement, a sample drying process was performed at 150° C. for 2 hours in a convection oven to remove moisture from a sample. Measurement of latent heat was performed from 150 to 300° C. at a heating and cooling speed of 10° C./min under a constant nitrogen gas atmosphere of 20 ml/min.

### MEASUREMENT EXAMPLE

### Peeling Adhesion Test for Latent Heat Storage Composite

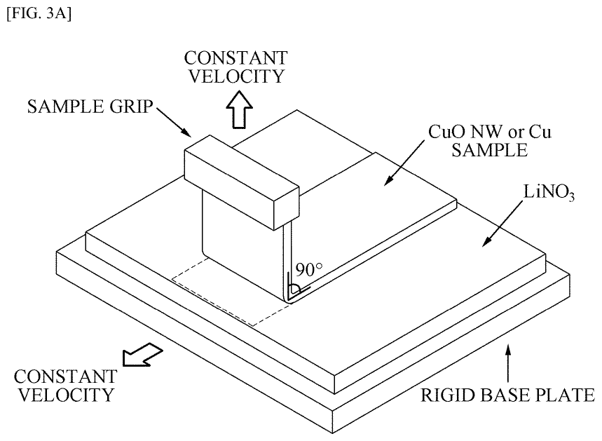

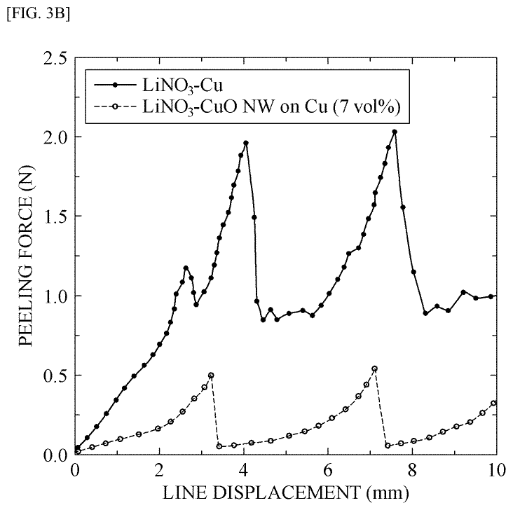

The peeling adhesion of the latent heat storage composite of Example 2 was measured according to the procedure of a 90° peeling test (ASTM D3330). Two samples were prepared by laminating a planar copper plate or a planar copper plate on which porous copper oxide nanowires were formed on lithium nitrate on the steel plate (“Rigid base plate” in FIG. 3A). The planar copper plate had a length of 15 cm, a width of 1.8 cm, and a height of 0.03 mm, and lithium nitrate had a length of 10 cm, a width of 5 cm, and a height of 1 cm.

A sample grip was fixed at 90° to one end of the planar copper plate or the planar copper plate on which porous copper oxide nanowires were formed, and peeling force by a load cell was measured while the grip and the plate were moved at a rate of 5 mm/min. Peeling force measurement was performed using a universal testing machine (LRX plus series, LLOYD instruments), and force resolution and measurement accuracy were 0.005 N and 0.5%, respectively.

### MEASUREMENT EXAMPLE

### Heat Storage Performance

For a heat storage test, a cylindrical anti-corrosion container (A1203) having inner/outer diameters of 5.5 cm and 6.0 cm, respectively, and a height of 9.0 cm was prepared. A scaffold of a folded copper mesh having a diameter of 5.0 cm and a height of 2.0 cm on which the porous copper oxide nanowires manufactured according to Manufacture Example 1 were formed was installed in the anti-corrosion container. Then, liquid lithium nitrate (molten lithium nitrate) was allowed to permeate the scaffold under vacuum conditions to form 7 vol % of a filler. Thereby, a solid latent heat storage composite (corresponding to the latent heat storage composite of Example 2) was manufactured.

The manufactured solid phase change material composite (7 vol % of a filler) and pure lithium nitrate were controlled to have a height of 2.0 cm. A cylindrical titanium cartridge heater had a constant electric power of 200 W under heating conditions (heat-on condition). Local temperature was observed using a type K thermocouple, and heat distribution was stored as an image by an infrared camera (T620, FLIR). Measurement uncertainty was ±2.2% due to the measurement errors of a heater (˜±2W) and a thermocouple (˜±0.17° C.).

Measurement Results

1. Porous copper oxide nanowires on folded copper mesh (Manufacture Example 1)

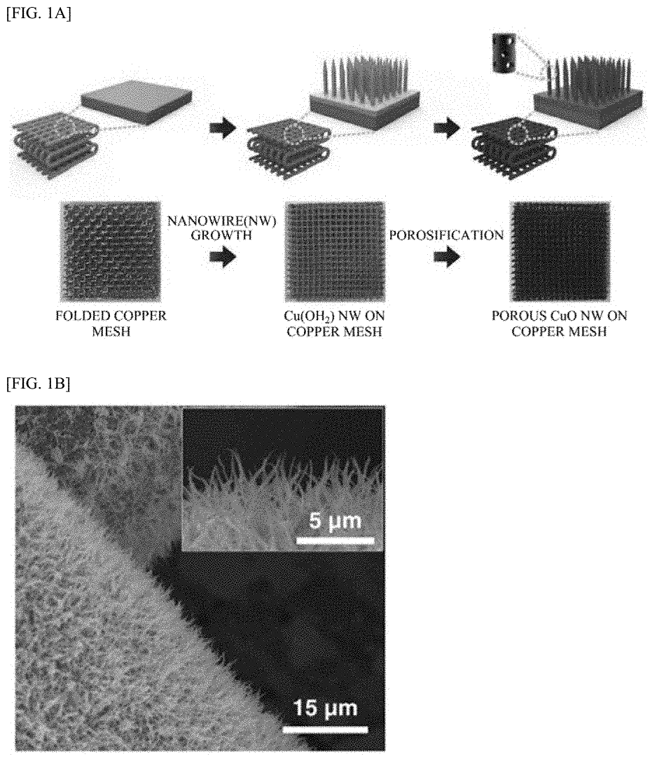

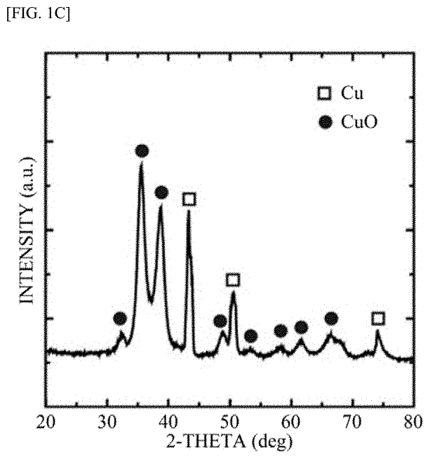

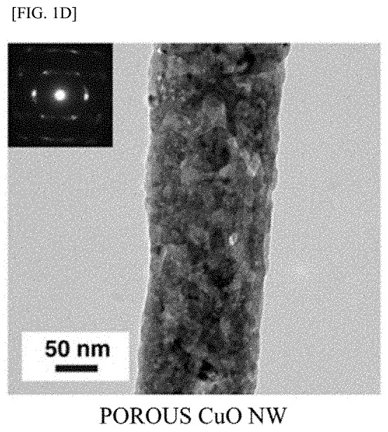

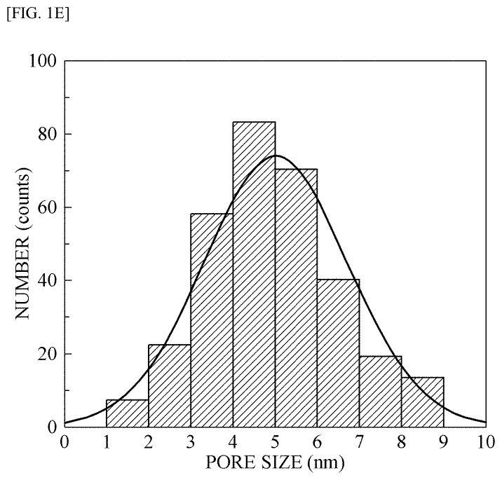

FIG. 1A is a schematic diagram showing a process of forming porous copper oxide (CuO) nanowires on a folded copper mesh (Manufacture Example 1). After washing the folded copper mesh, blue Cu(OH)₂ nanowires were first grown on the mesh using a chemical solution, and then a dehydration process was performed at 200° C. to convert the Cu(OH)₂ nanowires into porous copper oxide (CuO) nanowires. The synthesized porous copper oxide (CuO) nanowires were uniformly applied to the copper mesh, and the applied nanowires can be seen in FIG. 1B (SEM image). It can be seen that the XRD analysis of FIG. 1C is consistent with JCPDS data (number 00-045-0937). This result indicates that the synthesized nanowires are copper oxide (CuO).

In FIG. 1D, referring to the transmission electron microscope (TEM) image and the diffraction pattern, it can be confirmed that the synthesized porous copper oxide (CuO) nanowires have high porosity and high crystallinity.

In addition, referring to FIG. 1E, when the pore size distribution of the porous copper oxide (CuO) nanowires was analyzed, the porous copper oxide (CuO) nanowires had a pore size of 5.0±1.7 nm.

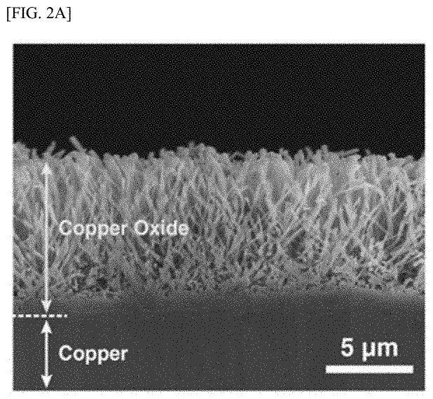

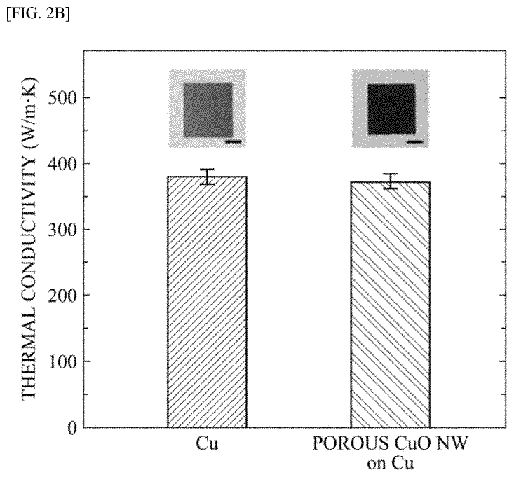

FIG. 2A shows the porous copper oxide (CuO) nanowires grown on the copper plate (Manufacture Example 2). The porous copper oxide (CuO) nanowires have a length of 6.6±1.1 and a diameter of 167.8±26.2 nm. The cross-sectional image of the porous copper oxide nanowires on the copper plate shows that a planar copper oxide (CuO) layer having a thickness of about 2 μm is formed on the copper (Cu) layer and the entire copper plate is coated with copper oxide, which suggests that the possibility of copper exposure to corrosive media is minimized. The thermal conductivity of the copper plate on which the porous copper oxide (CuO) nanowires are formed (porous CuO NW on Cu) and the thermal conductivity of the pure copper plate (Cu) are compared. Referring to FIG. 2B, the thermal conductivity of the copper plate on which the porous copper oxide is formed (FIG. 2B, Porous CuO NW on Cu) and the thermal conductivity of the pure copper plate (FIG. 2B, Cu) are 381±10 W/m·K and 376±10 W/m·K, respectively. These results indicate that the porous copper oxide nanowires do not affect the high-thermal conductivity of the copper plate. The thermal conductivity of the copper oxide (CuO) is 76 W/m·K, which is 2/10 that of Cu. This is because the thickness (about 2 μm×2) of the copper oxide layer formed on the copper plate and the height (about 6.6 μm×2) of the porous copper oxide nanowires on a surface are very small, showing about 10% of the height (about 180 μm) of the copper plate.

The spiky configuration of the porous copper oxide (CuO) nanowires formed on the copper plate may provide strong physical interaction with an adhesive material (phase change material). According to a 90° peeling test (ASTM D3330) shown in FIG. 3A, the critical peeling strength of the porous copper oxide (CuO) nanowires on the lithium nitrate (LiNO₃) layer and the critical peeling strength of the pure copper plate were measured. Referring to FIG. 3B, the peeling force of pure copper to the lithium nitrate layer (FIG. 3B, LiNO₃—Cu (red line)) is 0.1 to 0.5 N, and the peeling force of the porous copper oxide nanowires (FIG. 3B, LiNO₃—CuO NW on Cu (7 vol %) (blue line)) is 0.8 to 2.1 N. Morphological properties such as high-aspect-ratio geometrical configuration and high porosity may increase a specific surface area. In addition, due to the morphological properties, compared to the surface energy (˜1650 mJ/m²) of Cu, a copper oxide (CuO) layer having a surface energy of ˜2280 mJ/m² that enhances surface adhesion may be provided. Strong physical interaction between the phase change material and the thermally conductive filler material (such as mesh) may achieve stable operation in repeated heat cycles. On the other hand, when voids are formed therebetween, the thermal performance of the latent heat storage composite may deteriorate after heat cycles.

2. Thermal Properties

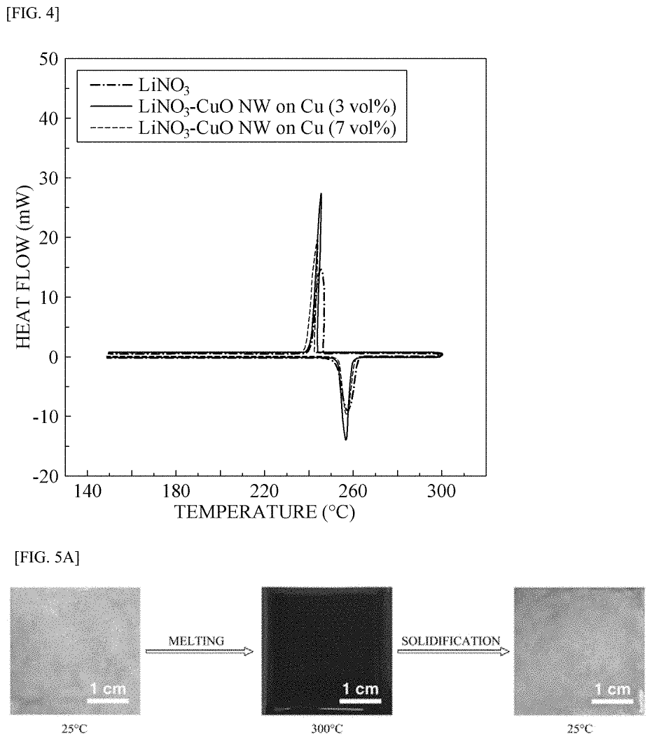

The latent heat of pure lithium nitrate, the latent heat of the latent heat storage composite of Example 1 including 3 vol % of a filler, and the latent heat of the latent heat storage composite of Example 2 including 7 vol % of a filler were analyzed using a differential scanning calorimeter (DSC) (DSC 4000, PERKIN ELMER), and the results are shown in FIG. 4. The melting temperatures and solidification temperatures of lithium nitrate (FIG. 4, LiNO₃ (black line)) and the latent heat storage composites of Example 1 (FIG. 4, LiNO₃—CuO NW on Cu (3 vol %) (red line)) and Example 2 (FIG. 4, LiNO₃—CuO NW on Cu (7 vol %) (blue line)) are 256° C. (lithium nitrate) and 244° C. (Examples 1 and 2), respectively. In addition, the latent heat of pure lithium nitrate, the latent heat of the latent heat storage composite of Example 1 including 3 vol % of a filler, and the latent heat of the latent heat storage composite of Example 2 including 7 vol % of a filler are 362±3 J/g (lithium nitrate), 319±4 J/g (Example 1), and 278±5 J/g (Example 2), respectively. These results are due to incorporation of the conductive filler.

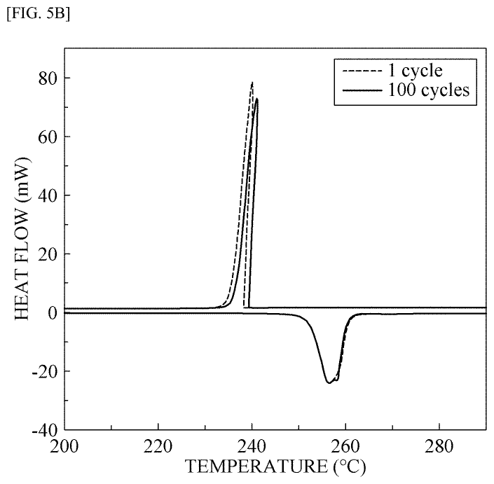

In addition, to investigate the stability of the phase change material, the stability of lithium nitrate and the stability of the latent heat storage composite of Example 2 including 7 vol % of a filler were analyzed during repeated melting and solidification, and the results are shown in FIGS. 5A to 5C. In FIG. 5A, it can be confirmed that, even in repeated cycles (25° C.>300° C.>25° C.), the porous copper oxide (CuO) nanowires are stably placed on the copper mesh in the latent heat storage composite. Referring to FIG. 5B, 100 heat cycles (FIG. 5B, 100 cycles (blue line)) do not significantly degrade thermal properties (less than 1%). In the corrosion process of lithium nitrate, lithium nitrate decomposes to form nitrogen dioxide (NO₂), which degrades thermal performance. In FIG. 5C, after 100 repeated heat cycles, in Fourier transform infrared (FTIR) spectra (FIG. 5C, 100 cycles (blue line)), a distinct NO₂ peak is not observed at a wavenumber of 1,250 cm⁻¹, and peaks representing LiNO₃ are observed. Thereamong, the peak at a wavenumber of ˜3,450 cm⁻¹ is related to an OH⁻ group. The absence of significant decomposition of lithium nitrate in repeated heat cycles is due to the fact that the copper oxide (CuO) layer exhibits excellent corrosion protection against nitrates.

The present disclosure provides improved heat transfer properties by predetermining the shape of the scaffold in the folding process of the copper mesh while maintaining a continuous network of the thermally conductive filler.

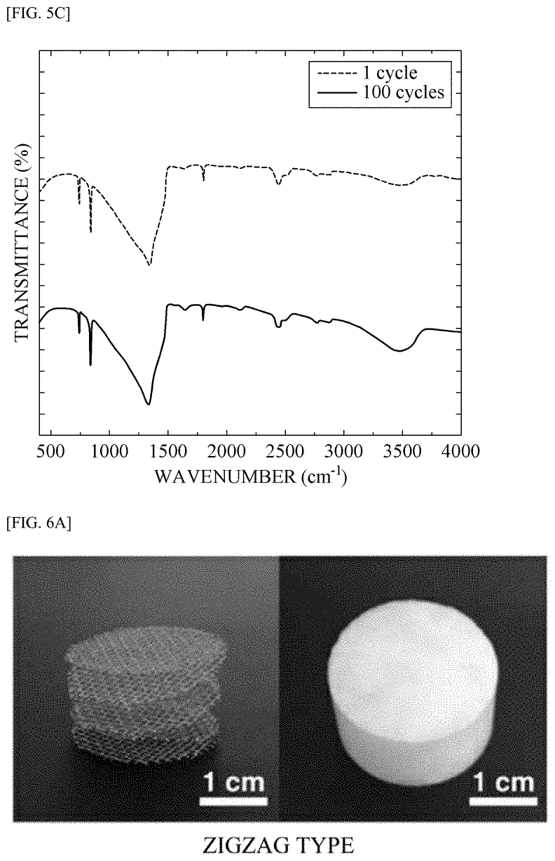

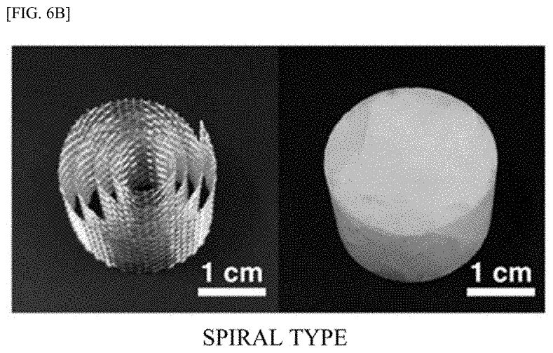

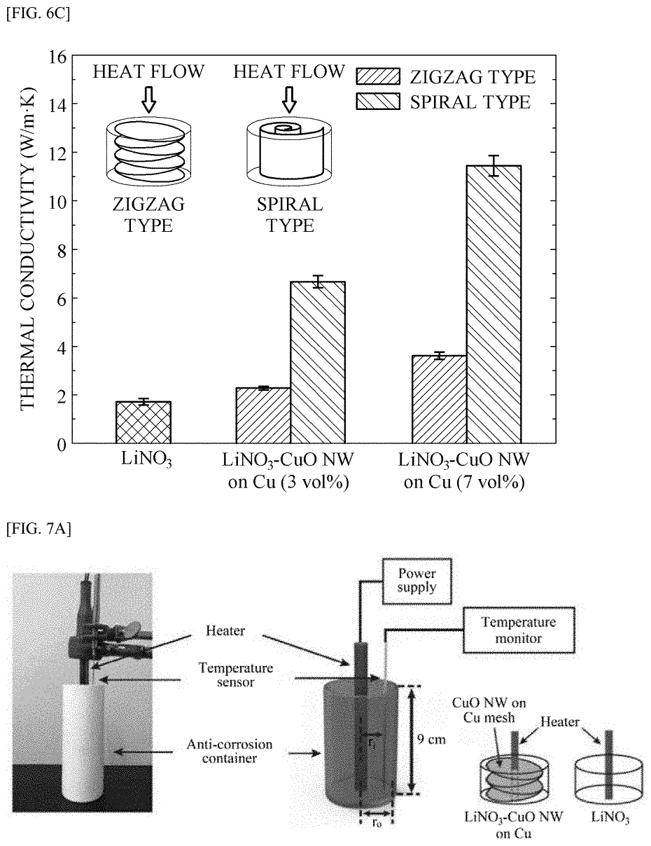

Two types of folded copper meshes (zigzag-type (FIG. 6A) and spiral-type (FIG. 6B)) according to Manufacture Example 1 are shown in FIGS. 6A and 6B. Referring to FIGS. 6A and 6B, the folding shape of a copper mesh is predetermined, and then porous copper oxide nanowires are synthesized on the copper mesh. Then, according to Examples 1 and 2, a cylindrical latent heat storage composite is synthesized through infiltration of lithium nitrate. Referring to FIG. 6C, the thermal conductivity of a latent heat storage composite may be experimentally measured using a one-dimensional steady-state method (ASTM D5470). Heat was applied to the upper part of the cylindrical latent heat storage composite. Referring to the inset of FIG. 6C, the zigzag type has thermal conductivity in the out-plane direction, and the spiral type has thermal conductivity in the in-plane direction. Even when volume percentages are the same, the number of folding may affect thermal conductivity. Accordingly, it should be noted that the volume percentage of the filler must be controlled at the fixed size (diameter: 2.5 cm, height: 1.5 cm) of a sample.

Referring to FIG. 6C, the zigzag-type latent heat storage composite (LiNO₃—CuO NW on Cu (3 vol %)) has a thermal conductivity of 2.3±0.1 W/m·K, the zigzag-type latent heat storage composite (LiNO₃-CuO NW on Cu (7 vol %)) has a thermal conductivity of 3.6±0.1 W/m·K, the spiral-type latent heat storage composite (LiNO₃—CuO NW on Cu (3 vol %)) has a thermal conductivity of 6.7±0.2W/m·K, and the spiral-type latent heat storage composite (LiNO₃—CuO NW on Cu (7 vol %)) has a thermal conductivity of 11.4±0.4 W/m·K. On the other hand, pure lithium nitrate (LiNO₃) has a thermal conductivity of 1.7±0.1 W/m·K. Due to the continuous network of the filler, when a small amount (7 vol %) of the filler is included based on lithium nitrate, the thermal conductivity of pure lithium nitrate is increased by 5.7 times. In addition, the spiral-type phase change composite has about 3.0 times higher thermal conductivity than the zigzag-type latent heat storage composite. This is because the spiral-type copper mesh is arranged parallel to a heat transfer direction. In this arrangement, heat may be transferred quickly and efficiently.

3. Heat Storage Performance

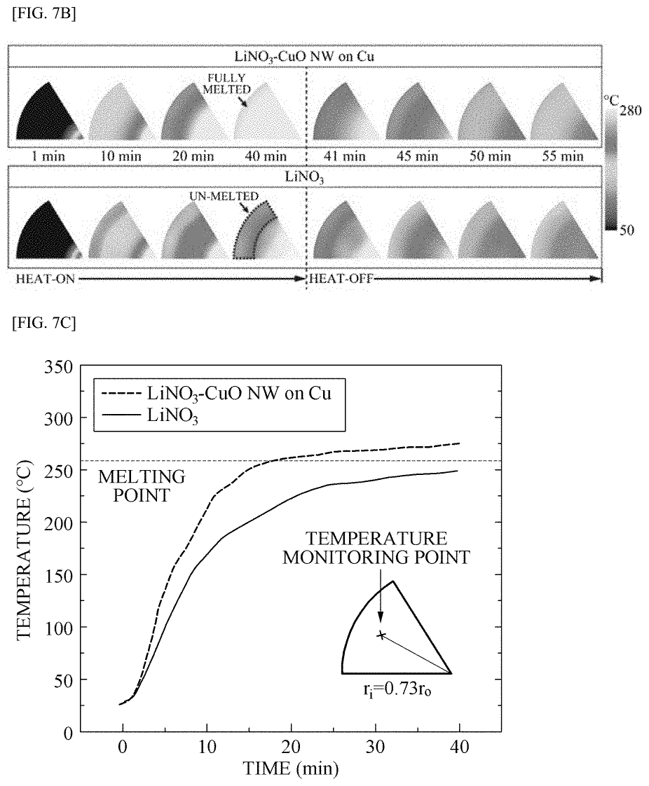

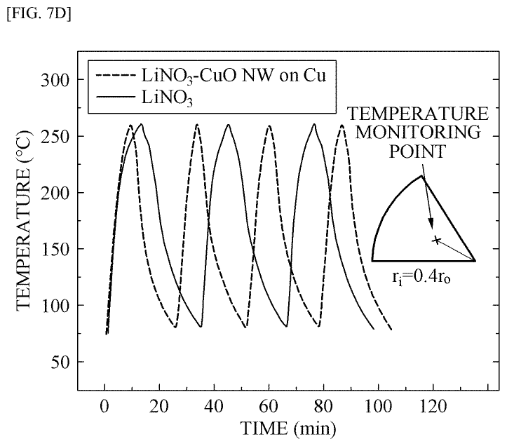

The thermal performance of the phase change composite was analyzed in terms of potential uses in heat storage, and the results are shown in FIGS. 7A to 7D. A circular ceramic insulator was filled with pure lithium nitrate or lithium nitrate or the latent heat storage composite of Example 2 including 7 vol % of the filler. To promote heat transfer, a folded copper mesh as in the image on the right side of FIG. 7A was designed, and the importance of heat transfer in the radial direction was considered. The inner and outer diameters of a circular specimen were 1.1 cm and 5.5 cm, respectively, and the height of the specimen was 2 cm. A constant heating power of 200 W was applied. First, in a heat-on process for 40 minutes and a heat-off process for 15 minutes, the temperature distribution of the sample in the radial direction was analyzed using an infrared thermal imaging camera, the results were visualized, and the visualized results are shown in FIG. 7B. Due to high thermal conductivity, the latent heat storage composite (FIG. 7B, LiNO₃—CuO NW on Cu) was completely dissolved within 40 minutes. Here, the accessible volume of the phase change material in a heat storage process is shown. However, for the same time, 50% of pure lithium nitrate (FIG. 7B, LiNO₃) was not dissolved. The small thermally-accessible volume of the phase change material is due to low thermal conductivity, which leads to inefficient use of thermal capacitive effect. Similarly, in the heat-off process, the latent heat storage composite releases stored heat faster than the pure phase change material. This is because heat release occurs from natural convection through the top of the anti-corrosion container.

When constant heating power was applied to the same area (2 cm from the center), the temperature profile of pure lithium nitrate (FIG. 7C, LiNO₃ (black line)) and the temperature profile of the latent heat storage composite (FIG. 7C, LiNO₃—CuO NW on Cu (red line)) were analyzed, and the results are shown in FIG. 7C. First, since the latent heat storage composite has improved thermal conductivity, the latent heat storage composite exhibits a faster heat charging rate than pure lithium nitrate at 0 to 18 minutes after heating. Second, after heat is applied to the latent heat storage composite for 18 minutes (heat-on), the temperature of lithium nitrate increases rapidly to the melting temperature thereof (about 256° C.), and the temperature of pure lithium nitrate reaches the melting temperature thereof after 40 minutes. These results suggest that a significant amount of heat may be stored simultaneously in most of the dissolved area of the phase change material in terms of heat storage. Based on these results, it can be seen that the folded mesh may improve thermal performance. In addition, it can be seen that a desired shape and a folded mesh may be used according to a specific target in consideration of a heat transfer direction.

In terms of heat storage, a heat cycle test was performed on pure lithium nitrate (FIG. 7D, LiNO₃ (black line)) and the latent heat storage composite (FIG. 7D, LiNO₃—CuO NW on Cu (red line)), and the results are shown in FIG. 7D. In a heat storage system, high temperature and low temperature were set to 260° C. and 80° C. for up to 100 minutes, respectively, and temperature change was observed.

The latent heat storage composite (LiNO₃/copper mesh on which porous copper oxide nanowires are formed) is capable of performing 4 heat cycles within the same period, and pure lithium nitrate is capable of performing 3 heat cycles. The average heating rates of pure lithium nitrate and the latent heat storage composite are 0.275° C./s (pure lithium nitrate) and 0.344° C./s (latent heat storage composite), respectively, and the average cooling rates thereof are 0.140° C./s (pure lithium nitrate) and 0.176° C./s (latent heat storage composite), respectively. The heat charging/discharging rate of the phase change composite is 1.3 times faster than that of pure lithium nitrate, and these results are due to the effective heat transfer properties of the phase change composite. When acquiring or releasing a certain amount of heat within a limited time, the fast heat charging and discharging in heat storage enables more effective heat management in applications including an automobile heat recovery system.

According to embodiment of the present disclosure, since a metal mesh is flexible, highly thermally conductive networks of various shapes can be manufactured depending on folding methods.

In addition, since a network is manufactured using a metal material having high thermal conductivity and high connectivity, the thermal conductivity of a latent heat storage material can be effectively improved, thereby increasing heat transfer rate.

In addition, protective nanostructures formed on the surface of a metal material can effectively prevent corrosion reaction between a phase change material and a metal network, thereby improving the stability of a latent heat storage composite.

Meanwhile, embodiments of the present disclosure disclosed in the present specification and drawings are only provided to aid in understanding of the present disclosure and the present disclosure is not limited to the embodiments. It will be apparent to those skilled in the art that various modifications can be made to the above-described exemplary embodiments of the present disclosure without departing from the spirit and scope of the invention.

What is claimed is:

1. A latent heat storage composite, comprising:
a flexible and foldable metal mesh;
a network of thermally conductive metal oxide structures formed on the metal mesh; and
a phase change material for applying the metal oxide structures.

2. The latent heat storage composite according to claim 1, wherein the metal mesh is a copper (Cu) mesh, an aluminum (Al) mesh, a nickel (Ni) mesh, a titanium (Ti) mesh, or a stainless steel mesh.

3. The latent heat storage composite according to claim 1, wherein the metal mesh is folded to have a shape created by combining one or more selected from the group consisting of a wave shape, a zigzag shape, a spiral shape, and a donut (co-annular) shape.

4. The latent heat storage composite according to claim 1, wherein the metal oxide structures are porous metal oxide nanowire structures applied to the metal mesh.

5. The latent heat storage composite according to claim 1, wherein the phase change material has a lower melting point than the metal mesh.

6. The latent heat storage composite according to claim 5, wherein the phase change material comprises organic phase change materials and molten salt-based, nitrate-based, chloride-based, or carbonate-based salt compound phase change materials.

7. The latent heat storage composite according to claim 1, wherein the latent heat storage composite controls thermal diffusion depending on change in a volume percentage between the metal mesh and the phase change material.

8. The latent heat storage composite according to claim 1, wherein the metal mesh has a volume percentage of 1 to 20 vol % based on the latent heat storage composite.

9. A method of manufacturing a latent heat storage composite, comprising:
preparing a metal mesh;
forming metal nanowire structures on the metal mesh;
heat-treating the metal nanowire structures to convert the metal nanowire structures into metal oxide nanowire structures; and
immersing, in a molten phase change material, the metal mesh on which the metal oxide nanowire structures are formed.

10. The method according to claim 9, wherein the metal mesh is a copper (Cu) mesh, an aluminum (Al) mesh, a nickel (Ni) mesh, a titanium (Ti) mesh, or a stainless steel mesh.

11. The method according to claim 9, wherein the metal mesh is folded to have a shape created by combining one or more selected from the group consisting of a wave shape, a zigzag shape, a spiral shape, and a donut (co-annular) shape.

12. The method according to claim 9, wherein the phase change material has a lower melting point than the metal mesh.

13. The method according to claim 12, wherein the phase change material comprises organic phase change materials and molten salt-based, nitrate-based, chloride-based, or carbonate-based salt compound phase change materials.

14. The method according to claim 9, wherein the metal mesh has a volume percentage of 1 to 20 vol % based on the latent heat storage composite.
